(19) United States
(12) Patent Application Publication
(10) Pub. No.: US 2006/0143459 A1
(43) Pub. Date: Jun. 29, 2006

(54) Method and system for managing personally identifiable information and sensitive information in an application-independent manner

(75) Inventors: Shawn Alan Villaron, San Jose, CA (US); Brian Jones, Redmond, WA (US); Chad Rothschiller, Edmonds, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/021,725

(22) Filed: Dec. 23, 2004

(51) Int. Cl. H04L 9/00

(52) U.S. Cl. 713/176

(57) ABSTRACT

Methods and systems are provided for managing personally identifiable and/or sensitive information (PII/SI) in a manner that is independent of a software application that is used for creating or editing a document containing the PII/SI. PII/SI in a document is marked or flagged in an application-independent manner so that a solution application programmed to discover and process marked PII/SI may readily discover the marked information for redacting the information, editing the information, or otherwise disposing of the information as desired. PII/SI in documents may be annotated according to the Extensible Markup Language (XML). A separate XML namespace may be used to distinguish the annotated PII/SI from other content in the document. An application-independent solution may be built for scanning a given document for all annotated information belonging to the namespace associated with the PII/SI. Once the annotated information is located in a given document, it may be redacted, edited, or otherwise processed or disposed of as desired.

### FIELD OF THE INVENTION

The present invention generally relates to management of data associated with software application files. More particularly, the present invention relates to methods and systems for managing personally identifiable information and sensitive information in an application—independent manner.

### BACKGROUND OF THE INVENTION

With the advent of the computer age, computer and software users have grown accustomed to user-friendly software applications that help then write, calculate, organize, prepare presentations, send and receive electronic mail, make music, and the like. For example, modem electronic word processing applications allow users to prepare a variety of useful documents. Modem spreadsheet applications allow users to enter, manipulate, and organize data. Modem electronic slide presentation applications allow users to create a variety of slide presentations containing text, pictures, data or other useful objects.

When documents are created and edited by such applications, various forms of data are often attached to, imbedded in or otherwise associated with the documents in the form of metadata or even normal content that should be controlled from access by subsequent users or recipients of the documents. For example, personally identifiable information may be exposed in macros, VBA code, comments, author tables, user edit blocks, paths and the like, so that even if a document author/editor deletes certain personally identifiable information from simple document properties, that information may still be exposed. For example, personally identifiable information associated with a document may provide information about the author or editor of the document including the author/editor's full name, the author/editor's manager's name, the author/editor's company name, and alike. Other types of data that may be associated with a document that should be controlled from exposure to third parties include revisions and comments to documents. That is, revisions and comments made in a document may be exposed to a subsequent user of the documents that may allow the user to know the content of drafts of a document that should not be exposed.

Similarly, paths may show up in a variety of unexpected places in various documents. For example, simple URLs/hyperlinks, link content, VBA code and template properties can expose path information. Such information can be used to determine the identity of others involved in authoring and editing a given document in a collaborative authoring session. Additionally, such information provides potential means for attack by hackers who may use the paths to learn of the topology of an organization's computing network.

In addition to such personally identifiable information, certain sensitive information may be included in documents that should be controlled from exposure to third party users. For example, a government agency may wish to send a document to certain users but may wish that certain information in the document should not be exposed to certain users.

The management of such personally identifiable and sensitive information has become particularly critical in an increasingly collaborative and electronic world. While the management of such information in a manner to prevent unauthorized access is often primarily focused on security, an equally important effort must be done to help prevent a user from accidentally disclosing such information through the simple exchange of document files.

It is with respect to these and other considerations that the present invention has been made.

### SUMMARY OF THE INVENTION

Embodiments of the present invention solved the above and other problems by providing methods and systems for managing personally identifiable and/or sensitive information (hereinafter PII/SI) in a manner that is independent of a software application that is used for creating or editing a document containing the PII/SI.

According to an embodiment of the invention, PII/SI in a document is marked or flagged in an application-independent manner so that a consuming application programmed to discover and handle marked PII/SI may readily discover the marked information for redacting the information, editing the information, or otherwise disposing of the information as desired. According to this embodiment, a single solution application may be built for scanning documents created and/or edited by a variety of different software applications for PII/SI. Such a single solution may be applied at the individual client application level (creation/editing application), or such a solution may be applied at a server level for handling PI/SI in all documents stored at or passed through the server.

According to another embodiment of the invention, PII/SI in documents is annotated according to the Extensible Markup Language (XML). A separate XML namespace is then used to distinguish the annotated PII/SI from other content in the document. An application-independent solution may then be built for scanning a given document for all annotated information belonging to the namespace associated with the PII/SI. Once the annotated information is located in a given document, it may be redacted, edited, or otherwise processed or disposed of as desired.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a block diagram showing the architecture of a personal computer that provides an illustrative operating environment for embodiments of the present invention.

FIG. 2 is a block diagram illustrating a relationship between a document containing PII/SI and an XML based solution according to embodiments of the present invention.

FIG. 3 is a flow diagram illustrating an illustrative routine for annotating PII/SI in a given document and for discovering the annotated PII/SI for processing by an application-independent solution according to embodiments of the present invention.

### DETAILED DESCRIPTION OF THE PREFERRED EMBODIMENT

As briefly described above, embodiments of the present invention are directed to methods and systems for managing personally identifiable information and/or sensitive information (PII/SI) in a manner that is independent of a software application that is used for creating or editing a document containing the information. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

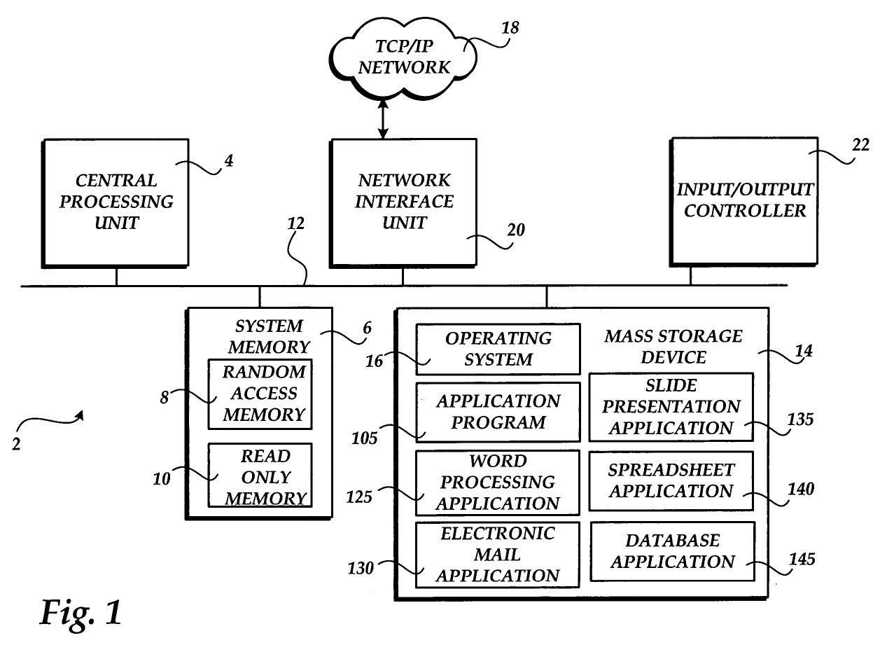

Referring now to the drawings, in which like numerals represent like elements through the several figures, aspects of the present invention and the exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Turning now to FIG. 1, an illustrative computer architecture for a personal computer 2 for practicing the various embodiments of the invention will be described. The computer architecture shown in FIG. 1 illustrates a conventional personal computer, including a central processing unit 4 (“CPU”), a system memory 6, including a random access memory 8 (“RAM”) and a read-only memory (“ROM”) 10, and a system bus 12 that couples the memory to the CPU 4. A basic input/output system containing the basic routines that help to transfer information between elements within the computer, such as during startup, is stored in the ROM 10. The personal computer 2 further includes a mass storage device 14 for storing an operating system 16, application programs, such as the application program 205, and data.

The mass storage device 14 is connected to the CPU 4 through a mass storage controller (not shown) connected to the bus 12. The mass storage device 14 and its associated computer-readable media, provide non-volatile storage for the personal computer 2. Although the description of computer-readable media contained herein refers to a mass storage device, such as a hard disk or CD-ROM drive, it should be appreciated by those skilled in the art that computer-readable media can be any available media that can be accessed by the personal computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the personal computer 2 may operate in a networked environment using logical connections to remote computers through a TCP/IP network 18, such as the Internet. The personal computer 2 may connect to the TCP/IP network 18 through a network interface unit 20 connected to the bus 12. It should be appreciated that the network interface unit 20 may also be utilized to connect to other types of networks and remote computer systems. The personal computer 2 may also include an input/output controller 22 for receiving and processing input from a number of devices, including a keyboard or mouse (not shown). Similarly, an input/output controller 22 may provide output to a display screen, a printer, or other type of output device.

As mentioned briefly above, a number of program modules and data files may be stored in the mass storage device 14 and RAM 8 of the personal computer 2, including an operating system 16 suitable for controlling the operation of a networked personal computer, such as the WINDOWS operating systems from Microsoft Corporation of Redmond, Wash. The mass storage device 14 and RAM 8 may also store one or more application programs. In particular, the mass storage device 14 and RAM 8 may store an application program 105 for providing a variety of functionalities to a user. For instance, the application program 105 may comprise many types of programs such as a word processing application, a spreadsheet application, a desktop publishing application, and the like. According to an embodiment of the present invention, the application program 105 comprises a multiple functionality software application suite for providing functionality from a number of different software applications. Some of the individual program modules that may comprise the multiple functionality application suite 105 include a word processing application 125, a slide presentation application 135, a spreadsheet application 140 and a database application 145. An example of such a multiple functionality application suite 205 is OFFICE manufactured by Microsoft Corporation. Other software applications illustrated in FIG. 1 include an electronic mail application 130.

According to embodiments of the present invention, personally identifiable information and/or sensitive information is marked in a document in a manner that is independent of the application that creates or edits the document. A given document may be created and/or edited by a word processing application, a spreadsheet application, a slide presentation application, and the like. As described above, various forms of personally identifiable information, for example, an author's name, editing dates, author's manager's name, author's office location, and the like may be attached to or associated with the document and may be accessible by others receiving and/or reviewing the document. Similarly, various types of content may be contained in a given document that may be sensitive in nature, for example, confidential business information or secret government information.

According to embodiments of the present invention, such personally identifiable information and/or sensitive information (PII/SI) is marked in the document so that the information may be readily discovered and processed as desired. According to one embodiment of the present invention, the PII/SI is marked in a manner that is independent of the particular programming of the application responsible for creating or editing the document. Accordingly, a solution application may be built for locating PII/SI in a document independent of the application responsible for creating or editing the document. Once the marked information is located a document, the solution application may process the marked information, as desired. For example, the marked information may be redacted from the document. For example, if it is desired that the author's name and identification information should be redacted from all documents to be sent to a given location, the solution application may parse such documents to locate the PII/SI marked in the documents followed by a redaction of the PII/SI information before allowing the documents to be forwarded to the intended recipients.

Similarly, the solution application may be utilized for editing PII/SI. For example, if it is acceptable to allow a receiving user to see an author's name, but it is not acceptable to allow a receiving user to view changes or edits made to a document, the solution application may be programmed to edit the PII/SI discovered in the document to leave the identification of the author, but to redact the changes or editing information associated with the document. In the case of sensitive information or content, the solution application may similarly redact or otherwise edit the sensitive information. For example, if a document contains sensitive government information that has been marked as PII/SI, the solution application, upon locating the marked sensitive information, may replace the sensitive information in the document with a phrase such as “redacted sensitive information.” Or, the solution application may redact the marked sensitive information altogether.

According to embodiments of the present invention, the solution application that is responsible for parsing the document to locate and process the PII/SI may be part of a multiple application suite that may be called upon to process PII/SI after the creation of a document prepared by one of the applications of the multiple application suite before the document is passed to a third party user. Alternatively, the solution application may be located at a server in a distributed computing environment and may be utilized for processing PII/SI for all documents stored at the server that are accessible by third party users. Alternatively, the solution application may be located on an electronic mail server for managing PII/SI of all documents passed through the server to third party users.

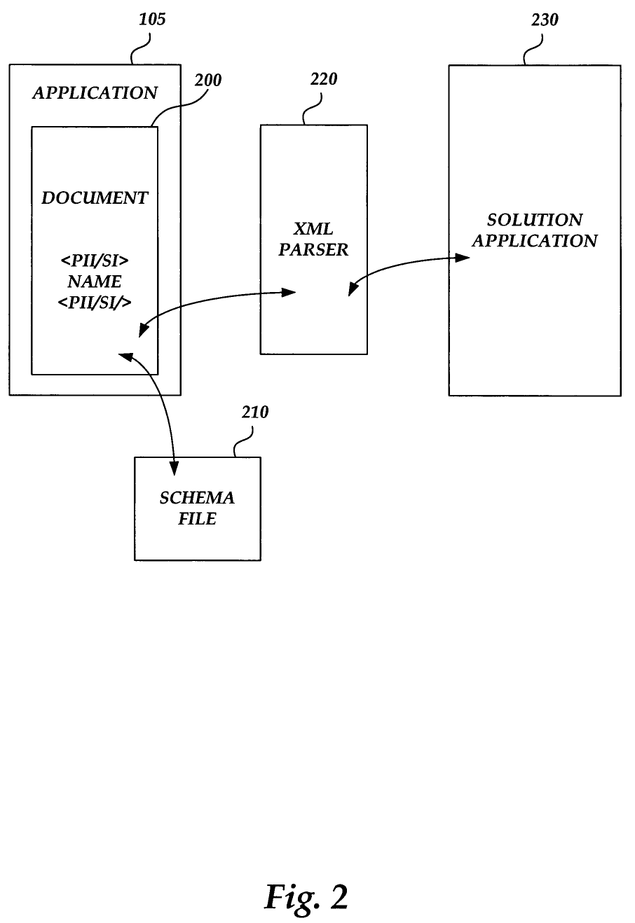

Referring now to FIG. 2, according to a particular embodiment of the present invention, personally identifiable information and/or sensitive information (PII/SI), is annotated in a given document using markup tags of the Extensible Markup Language (XML). According to this embodiment, once PII/SI is identified in a given document as the document is being created and/or edited, the identified PII/SI is annotated with XML markup tags that are associated with an XML namespace separate from the XML namespace of other content of the document so that the PII/SI may be readily distinguished from non-PII/SI information or content in the document by an XML parser. Referring to FIG. 2, an application 105 is illustrated wherein a document 200 has been created and/or edited. A particular piece of PII/SI, for example “name”, has been annotated with XML markup tags so that the identified PII/SI may be located by a an XML parser 220 associated with a solution application 230.

According to embodiments of the invention, the document 200 is associated with a schema file 210 for defining the XML applied to the document, including the XML markup tags applied to identified PII/SI and including a definition of an associated namespace utilized for the particular XML markup tags used for annotating identified PII/SI. Accordingly, a solution application 230 in association with the XML parser 220 may parse any document prepared by any application to locate PII/SI annotated with the XML markup tags. That is, so long as the solution application 230, in association with the XML parser 220, may read the schema file 210, the solution application 230 may locate identified and marked PII/SI based on the namespace associated with the markup tags applied to the PII/SI. Once the PII/SI is located, the solution application 230 may then manage and/or process the identified PII/SI to include redacting the information, editing the information, or otherwise disposing of the information as desired.

As described above, the solution application 230 and associated XML parser 220 may be a part of a multiple application suite containing different applications such as word processing applications, spreadsheet applications, slide presentation applications, and the like. Alternatively, the solution application 230 may be a stand-alone application that may be called by a user for processing PII/SI in a given document. Alternatively, as described above, the solution application 230 and the associated XML parser 220 may be located at a server for managing PII/SI contained in documents stored at or passing through the server to third party users.

By way of example, the following is an XML representation of a word processing document. In the example XML representation, a sample text content entry of “Here is a sample text” is included. Additionally, a portion of personally identifiable information is also included in the document, including the phrase “My name is Joe Smith” identifying the author of the document. As can be seen, the personally identifiable information in this document has not been annotated nor marked in any way to distinguish the PII/SI from other content of the document. Consequently, locating the PII/SI is difficult.

<?xml version=“1.0” encoding=“UTF-8” standalone=“yes”?>
<?mso-application progid=“Word.Document”?>
<w:wordDocument
xmlns:w=http://schemas.microsoft.com/office/word/2003/wordml
xmlns:o=“urn:schemas-microsoft-com:office:office”
xml:space=“preserve”>
<w:p>
<w:r>

<w:t>Here is sample text</w:t>

</w:r>
</w:p>
<w:p>
<w:r>

<w:t>My name is Joe Smith</w:t>

</w:r>
</w:p>

According embodiments of the present invention, the following is an XML representation of the same word processing document, described above, where the PII/SI has been annotated with XML markup associated with a an XML namespace highlighted in boldface text.

<?xml version=“1.0” encoding=“UTF-8” standalone=“yes”?>
<?mso-application progid=“Word.Document”?>
<w:wordDocument
xmlns:w=http://schemas.microsoft.com/office/word/2003/wordml
xmlns:o=“urn:schemas-microsoft-com:office:office”
xmlns:pii=“urn:schemas-
microsoft-com:pii”xml:space=“preserve”>
<w:p>

<w:r>

<w:t>Here is sample text</w:t>

</w:r>

</w:p>
<w:p>

<w:r>

<w:t>My name is</w:t>

</w:r>
<w:r>

<w:rPr>

<pii:name/>

</w:rPr>
<w:t>Joe Smith</w:t>

</w:r>

</w:p>

Now that the PII in the XML representation of the example word processing document has been marked with XML annotation associated with the PII/SI namespace, a solution application 230, in association with an XML parser 220, may readily parse the XML represented document to locate the PII/SI annotated according to the PII/SI namespace. As set out below, the XML represented document is illustrated after a solution application 230 has located and redacted the undesirable PII/SI. In effect, each PII/SI namespace used to identify and manage the PII/SI becomes a simple transform that can be run against any document using a file format wherein PII/SI is marked for identification according to embodiment of the present invention.

<?xml version=“1.0” encoding=“UTF-8” standalone=“yes”?>
<?mso-application progid=“Word.Document”?>
<w:wordDocument
xmlns:w=http://schemas.microsoft.com/office/word/2003/wordml
xmlns:o=“urn:schemas-microsoft-com:office:office”
xmlns:pii=“urn:schemas-
microsoft-com:pii”xml:space=“preserve”>
<w:p>

<w:r>

<w:t>Here is sample text</w:t>

</w:r>

</w:p>
<w:p>

<w:r>

<w:t>My name is</w:t>

</w:r>
<w:r>

<w:rPr>

<pii:name/>

</w:rPr>
<w:t>REDACTED</w:t>

</w:r>

</w:p>

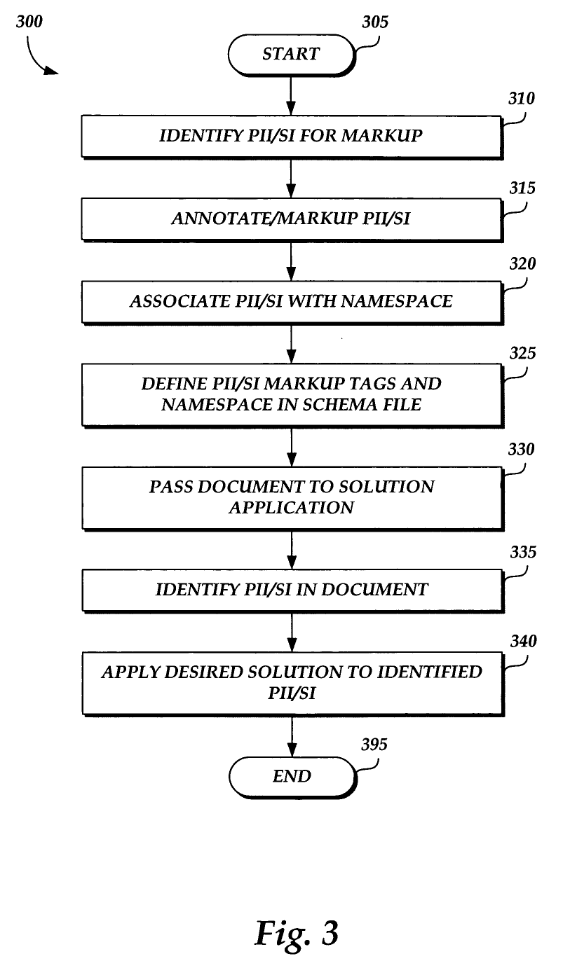

Having described embodiments of the present invention with respect to FIGS. 1 and 2 above, FIG. 3 is a flow diagram illustrating an illustrative routine for annotating PII/SI in a given document and for discovering the annotated PII/SI for processing by an application-independent solution application according to embodiments of the present invention. The routine 300 begins at start block 305 and proceeds to block 310, where personally identifiable information and/or sensitive information is identified in a document 200 by an author or editor of the document. As should be understood, personally identifiable information may be included in information considered sensitive information. That is,” personally identifiable information may in some cases be a subset of sensitive information contained in or associated with a given document or file. At block 315, in accordance with embodiments of the present invention, the PII/SI identified by the author/editor or administrator of the document is annotated with XML tags, as set forth above. At block 320, the document and annotated PII/SI are associated with a PII/SI namespace. At block 325, the PII/SI tags and associated namespace are defined in a schema file associated with the document. As described above, a document with PII/SI identified and marked as described herein may be any document prepared by any number of different types of applications including word processing applications, spreadsheet applications, slide presentation applications, and alike.

At block 330, the document having marked and annotated PII/SI as described herein is passed to a solution application 230 for discovering and managing or otherwise processing any identified PII/SI. As described above, the solution application 230 and associated XML parser 220 may be a part of the application 105 used by the author/editor of the document 200. Alternatively, the solution application 230 may be a stand-alone application that may be called an author, editor of administrator of the document 200 for locating and managing PII/SI. Alternatively, the solution application 230 may be located at a server at which the document 200 may be stored or through which the document may be passed for receipt by a third party user.

At block 330, the document is parsed by the XML parser 220 for locating PII/SI marked up with XML tags identified as part of the PII/SI namespace as defined by the associated schema file 210. At block 335, the annotated PII/SI is identified as PII/SI. At 340, the solution application 230 is applied to the identified PII/SI as desired. For example, the identified PII/SI may be redacted, edited, or other information not defined as PII/SI may be inserted into the document as replacement information or content for the identified PII/SI. The method ends at block 395.

As described herein, methods and systems are provided for managing and/or processing personally identifiable information and/or sensitive information in a manner that is independent of a software application used for creating or editing a document containing the information. It will be apparent to those skilled in the art that various modifications and variations may be made in the present invention without departing from the scope or spirit of the invention. Other embodiments of the invention will be apparent to those skilled in the art from consideration of the specification and practice of the invention disclosed herein.

We claim:

1. A computer-readable medium having stored thereon computer-executable instructions which when executed by a computer perform a method of managing sensitive information in a computer-generated document, comprising:
receiving an identification of sensitive information in a computer-generated document;
receiving a marking of the identified sensitive information in the document electronically to allow the marked sensitive information to be detected;
parsing the document for locating the marked sensitive information;
locating the marked sensitive information in the document; and
modifying the marked sensitive information located in the document.

2. The computer-readable medium of claim 1, whereby identifying sensitive information in the computer-generated document includes identifying sensitive information that should not be passed to all users of the document.

3. The computer-readable medium of claim 2, whereby receiving an identification of the sensitive information includes receiving and identification of personally identifiable information in the document that identifies attributes associated with an author or editor of the document.

4. The computer-readable medium of claim 1, further comprising defining one or more markings for marking the identified sensitive information in the document electronically to allow the marked sensitive information to be detected.

5. The computer-readable medium of claim 1, prior to parsing the document for locating the marked sensitive information, passing the document to a sensitive information solution application for processing located sensitive information contained in the document.

6. The computer-readable medium of claim 1, whereby modifying the marked sensitive information in the document includes redacting the marked sensitive information from the document.

7. The computer-readable medium of claim 1, whereby modifying the marked sensitive information in the document includes replacing the marked sensitive information located in the document with non-sensitive information.

8. The computer-readable medium of claim 1,
whereby receiving a marking of the identified sensitive information in the document electronically to allow the marked sensitive information to be detected includes receiving an application of Extensible Markup Language (XML) tags to the identified sensitive information; and
whereby parsing the document for locating the marked sensitive information includes parsing the document for locating the XML tags applied to the identified sensitive information.

9. The computer-readable medium of claim 8, whereby modifying the marked sensitive information in the document includes modifying the sensitive information tagged with the XML tags.

10. The computer-readable medium of claim 8, further comprising associating the XML tags applied to the identified sensitive information with an XML namespace.

11. The computer-readable medium of claim 10, further comprising defining the XML tags applied to the identified sensitive information and defining the XML namespace in an XML schema file associated with the document.

12. The computer-readable medium of claim 8, prior to parsing the document for locating the XML tags applied to the sensitive information, passing the document to a solution application enabled to parse the document for locating the XML tags applied to the sensitive information.

13. The computer-readable medium of claim 12, further comprising reading the XML schema file associated with the document for obtaining names and definitions associated with the XML tags applied to the identified sensitive information.

14. A method of managing sensitive information in a computer-generated document, comprising:
receiving an application of Extensible Markup Language (XML) tags to sensitive information in a computer-generated document for marking the sensitive information to allow the marked sensitive information to be detected;
parsing the document for locating the XML tags applied to the marked sensitive information; and
upon locating the marked sensitive information in the document, modifying the marked sensitive information in the document.

15. The method of claim 14, further comprising associating the XML tags applied to the sensitive information with an XML namespace.

16. A computer-readable medium having stored thereon computer-executable instructions which when executed by a computer perform a method of managing sensitive information in a computer-generated document, comprising:
receiving an identification of personally identifiable information in a computer-generated document;
receiving an application of Extensible Markup Language (XML) tags to the identified personally identifiable information to allow the marked personally identifiable information to be detected;
parsing the document for locating the XML tags applied to the identified personally identifiable information;
locating the marked personally identifiable information in the document; and
modifying the marked personally identifiable information located in the document.

17. The computer-readable medium of claim 16, whereby modifying the marked personally identifiable information in the document includes redacting the marked personally identifiable information from the document.

18. The computer-readable medium of claim 16, whereby modifying the marked personally identifiable information in the document includes replacing the marked personally identifiable information located in the document with non-personally identifiable information.

19. The computer-readable medium of claim 16, further comprising associating the XML tags applied to the identified personally identifiable information with an XML namespace.

20. The computer-readable medium of claim 19, further comprising:
prior to parsing the document for locating the XML tags applied to the personally identifiable information, passing the document to a solution application enabled to parse the document for locating the XML tags applied to the personally identifiable information; and
reading an XML schema file associated with the document for obtaining names and definitions associated with the XML tags applied to the identified personally identifiable information.
